(19) United States
(12) Patent Application Publication
(10) Pub. No.: US 2009/0245852 A1
(43) Pub. Date: Oct. 1, 2009

(54) TONER SUPPLY DEVICE, DEVELOPING UNIT AND TONER SUPPLY DEVICE REMANUFACTURING METHOD

(76) Inventors: Takahiko KIMURA, Ikoma-shi (JP); Tomoya USUI, Yamatokoriyama-shi (JP); Masanobu DEGUCHI, Kashiba-shi (JP); Teruyoshi SUDOH, Yamatokoriyama-shi (JP)

Correspondence Address: BIRCH STEWART KOLASCH & BIRCH, PO BOX 747, FALLS CHURCH, VA, 22040-0747, US

(21) Appl. No.: 12/401,285

(22) Filed: Mar. 10, 2009

(30) Foreign Application Priority Data
Mar. 27, 2008 (JP) 2008-82651

(51) Int. Cl. G03G 15/08

(52) U.S. Cl. 399/103

(57) ABSTRACT

A toner supply device includes a toner storage tank for storing toner; a toner supply roller for discharging toner; a covering member for covering the top surface of the toner storage tank filled with toner; and a sealing element provided between the toner storage tank and the covering member.

This Nonprovisional application claims priority under 35 U.S.C. §119(a) on Patent Application No. 2008-82651 filed in Japan on 27 Mar. 2008, the entire contents of which are hereby incorporated by reference.

### BACKGROUND OF THE INVENTION

(1) Field of the Invention

The present invention relates to a toner supply device including a toner supply roller, for use in an image forming apparatus for forming images with toner and a developing unit using the toner supply device as well as to a toner supply device remanufacturing method.

(2) Description of the Prior Art

Conventionally, in image forming apparatuses using toner, such as copiers, facsimile machines, etc., a toner supply device such as a toner container, toner cartridge or the like is used to supply toner to the developing unit so as to deal with continuous operation of image output.

Since toner supply devices such as toner containers, toner cartridges, etc., receive vibrations and impacts during shipment and transportation, they have a sealed structure in order to prevent the toner held therein from spilling out.

For example, Japanese Patent Application Laid-open Hei 11 No. 143203 (patent document 1) discloses a developing unit which is formed of a resinous toner casing for a toner storage and a resinous development casing as a supporting structure of the parts for development, the casings being joined to each other by vibration welding, ultrasonic welding, thermal welding or the like.

Also, Japanese Patent Application Laid-open Hei 04 No. 293066 (patent document 2) discloses a process cartridge in which, in order to prevent a seal film from being torn when the seal film is peeled off, the joint plane between the developer reserving container and the developer storage container is formed so as to be different from the plane of the sealing surface of the seal film.

However, in the kinds of the toner supply devices disclosed in patent documents 1 and 2, no remanufacturing process has been taken into account. Hence, when the device is disjoined or broken down at the joint plane, burrs and cracks arise at the resin surfaces, so that it is impossible to reuse them or it is necessary to prepare a new storage container (storage casing) and the like.

More specifically, as shown in FIG. 1, the aforementioned toner supply devices 300 up to now have a form in which the toner storage tank 301 and its covering member 303 (lid) are hermetically sealed by ultrasonic welding or the like in order to prevent toner leakage during shipment and transportation, hence they have been not ones that are designed on the premise that they will be remanufactured. Accordingly, when the toner in the process cartridge runs out, there has been no way other than that the cartridge is discarded as it is or put to the plastic recycling process. Here, in FIG. 1, numeral 304 designates toner supply roller, numeral 305 designates toner agitation shaft base and numeral 306 designates toner conveying member.

However, in recent years, there are increased demands for consideration to environmental issues, a simple method that enables remanufacturing of the process cartridges is demanded. In particular, as to the toner supply containers including various parts such as a toner supply roller etc., it is necessary to collect each part individually and separately, hence it is not a good measure to discard them or bring them to a plastic recycling process.

### SUMMARY OF THE INVENTION

The present invention has been devised in view of the conventional problems described above, it is therefore an object of the present invention to provide a toner supply device including a toner supply container filled with toner, which is reduced in the remanufacturing time when it is remanufactured and hence is reduced in the total cost.

In order to achieve the above object, the toner supply device according to the present invention and the developing unit using the toner supply device are each configured as follows:

A toner supply device according to the present invention includes: a toner storage tank for storing toner; a toner supply roller for discharging toner; and a covering member for covering the top surface of the toner storage tank filled with toner, and is characterized in that a sealing element is provided between the toner storage tank and the covering member.

The toner supply device is further characterized in that the sealing element is formed of a heat sealing material.

The toner supply device may further include: a toner conveying member for conveying toner; and a toner agitation shaft base for supporting the toner conveying member.

The toner supply device is further characterized in that the toner agitation shaft base is formed of PS resin or ABS resin.

A developing unit according to the present invention is characterized by use of one of the above-described toner supply devices.

A toner supply device remanufacturing method according to the present invention for remanufacturing a toner supply device including a toner storage tank for storing toner; a toner supply roller for discharging toner; a covering member for covering the top surface of the toner storage tank filled with toner; and a sealing element provided between the toner storage tank and the covering member, comprises the steps of: cleaning a used toner storage tank; loading the cleaned tank with the toner; hermetically closing the toner storage tank filled with the toner with a new sealing element; and, covering with the covering member the toner storage tank closed with the new sealing element.

The toner supply device remanufacturing method according to the present invention is further characterized in that the replaced new toner sealing element is applied with slack so as to hermetically close the toner storage tank.

According to the toner supply device of the present invention and the image forming apparatus using this, excellent effects as follows can be obtained.

According to the toner supply device of the present invention, since the toner supply device including: a toner storage tank for storing toner; a toner supply roller for discharging toner; and a covering member for covering the top surface of the toner storage tank filled with toner, is provided with a sealing element between the toner storage tank and the covering member, it is possible to prevent toner leakage during shipment and transportation. Further, since the toner storage tank and the covering member can be reused in remanufacturing the toner supply device, this configuration is excellent as the measures against environmental issues. Further, this configuration can reduce production time and increase the parts that can be recycled, hence it is possible to cut down the total cost.

Further, according to the toner supply device of the present invention, since the sealing element is formed of a heat sealing material, it is possible to secure the necessary sealing performance by simple application of heat. As to mechanical strength, there is no practical problem since the covering member can provide reinforcement.

According to the toner supply device of the present invention, since the device further includes a toner conveying member for conveying toner and a toner agitation shaft base for supporting the toner conveying member, it is possible to discharge all the toner inside the toner supply device. Accordingly, no waste time will be spent in toner cleaning during remanufacturing.

According to the toner supply device of the present invention, since the toner agitation shaft base is formed of PS resin or ABS resin, it is possible to produce it easily and secure mechanical strength with the inexpensive material.

According to the developing unit of the present invention, since use of one of the above toner supply devices makes it possible to use up the toner in the toner supply device, it is possible to lengthen the life of the developing unit.

According to the remanufacturing method of the toner supply device of the present invention, since the toner supply device remanufacturing method of a including: a toner storage tank for storing toner; a toner supply roller for discharging toner; a covering member for covering the top surface of the toner storage tank filled with toner; and a sealing element provided between the toner storage tank and the covering member, comprises the steps of: cleaning a used toner storage tank; loading the cleaned tank with the toner; hermetically closing the toner storage tank filled with the toner with a new sealing element; and, covering with the covering member the toner storage tank closed with the new sealing element. Accordingly, the toner storage tank and the covering member can be reused in remanufacturing the toner supply device, hence this configuration is excellent as the measures against environmental issues. Further, this configuration can reduce production time and increase the parts that can be recycled, hence it is possible to cut down the total cost.

Further, according to the remanufacturing method of the toner supply device of the present invention, slack application of the replaced new toner sealing element to hermetically close the toner storage tank, makes it possible to inhibit spilling of the toner from the container which would occur when a sudden reduction in air pressure takes place during air transportation etc.

### BRIEF DESCRIPTION OF THE DRAWINGS

FIG. 1 is an exploded perspective view showing a conventional toner supply device;

FIG. 2 is an overall schematic configurational view showing an image forming apparatus according to the present invention;

FIG. 3 is a sectional view showing a toner supply device and a developing unit according to the present invention;

FIG. 4 is a perspective view showing a toner supply device and a developing unit according to the present invention;

FIG. 5 is a perspective view showing a toner supply device according to the present invention; and, FIG. 6 is an exploded perspective view showing a toner supply device according to the present invention.

### DESCRIPTION OF THE PREFERRED EMBODIMENTS

A preferred embodiment of the present invention will hereinafter be briefly described with reference to the accompanying drawings. Here, in this specification and drawings, repeated description of constituents having substantially the same functional configurations will be omitted by allotting the same reference numerals.

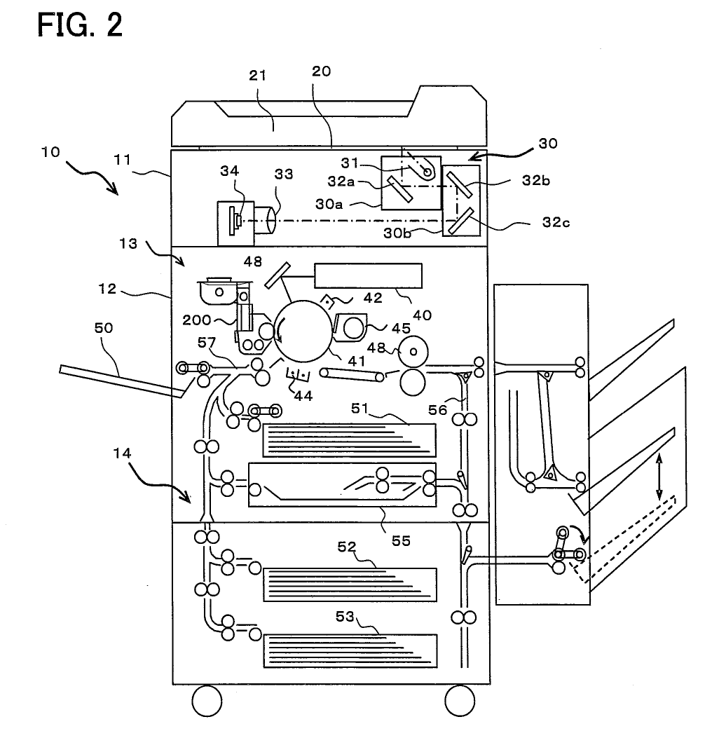

FIG. 2 is a schematic configurational view showing the overall configuration of an image forming apparatus (digital copier) on which a toner supply device (developer supply device) according to the present invention is mounted.

As shown in FIG. 2, a digital copier 10 is essentially composed of a scanner portion 11 and a printer portion 12 including an image forming portion 13, a paper feed portion 14, etc.

### (Description of Scanner Portion 11)

Arranged on a document table 20 made of transparent glass on the top surface of scanner portion 11 is an automatic document feeder 21. Automatic document feeder 21 is an device for automatically feeding the paper one page at a time to document table 20 from a plurality of documents set on a document set tray.

A document reader 30 is arranged under document table 20 to read an image by scanning the image of a document set on document table 20, and is composed of a first scan unit 30a, a second scan unit 30b, an optical lens 33 and a CCD line sensor 34 as a photo electric transducer. First scan unit 30a is composed of an exposure lamp unit 31 for illuminating the document surface, a first mirror 32a for reflecting the reflected image of light from the document in a predetermined direction, a frame for supporting these and the like. Second scan unit 30b is composed of a second mirror 32b and third mirror 32c for leading the reflected light of the document, from first mirror 32a, to CCD line sensor 34 as a photo electric transducer, a frame supporting these and the like. Optical lens 33 is to focus the reflected light from the document on CCD line sensor 34.

Document reader 30 reads the image of the document being automatically conveyed by automatic document feeder 21, at the predetermined exposure position, by the operation associated with automatic document feeder 21.

The image data of the document image read through this document reader 30 is transferred to an unillustrated image data input portion, subjected to the predetermined image processes, then the data is temporarily stored into the memory of the image processor. The data stored in the memory is read out in accordance with an output instruction and is transferred to a laser write unit 40 as an optical writer of image forming portion 13.

### (Description of Printer Portion 12)

Printer portion 12 is configured of image forming portion 13 that transfers the image data (image information) to the paper and paper feed portion 14 for conveying or handling the paper fed from the tray to image forming portion 13.

The image forming portion 13 herein is to form a monochrome image on a predetermined sheet (recording paper) in accordance with the image data supplied from without. As illustrated, the image forming portion essentially includes exposure unit 40 and a photoreceptor drum 41 as well as including around the photoreceptor drum 41, a charger 42 for electrifying photoreceptor drum 41 at a predetermined potential, a developing unit 200 for supplying toner to the electrostatic latent image formed on photoreceptor drum 41 to visualize it, a toner supply device 100 for supplying toner, a transfer device 44 (transfer charger etc.) for transferring the toner image formed on the photoreceptor drum 41 surface to the recording paper and a cleaner unit 45 for collecting surplus toner.

Exposure unit (laser write unit) 40 of image forming portion 13 is composed of a semiconductor laser light source for emitting a laser beam in accordance with the image data read out from the memory or the image data transferred from an external apparatus, a polygon mirror for deflecting the laser beam at an equiangular speed and an f-theta lens for correcting the laser beam deflected at an equiangular speed so that the laser spot on the photoreceptor drum 41 surface travels at a uniform speed. Though, in the present embodiment, a laser write unit is used as the writing device, a fixed scan type optical write head unit such as an LED or EL light emitting array or the like may be used.

Photoreceptor drum 41 is arranged (mounted) at the center of the image forming apparatus 10.

Charger 42 is a charging device for uniformly electrifying the photoreceptor drum 41 surface at a predetermined potential, and uses herein a non-contact type corona discharge type charger shown in FIG. 2. A contact-type charger, e.g., roller type charger or brush type charger may also be used instead. Exposure unit 40 may use a laser scanning unit (LSU) though not illustrated in FIG. 2. Other than this, an array of light emitting elements such as an EL or LED writing head may also be used. The exposure unit has the function of illuminating the electrified photoreceptor drum 41 in accordance with the input image data to form an electrostatic latent image corresponding to the image data on the photoreceptor drum surface. Developing unit 200 is to visualize the electrostatic latent image formed on photoreceptor drum 41 with toner. Cleaner unit 45 is to remove and collect the toner remaining on the photoreceptor drum 41 surface after development and image transfer.

The image information developed on photoreceptor drum 41 as in the above way is transferred to the paper by transfer device 44. The recording paper with the image transferred thereon is sent to a fusing unit 48 where the image is fused to the recording paper.

Paper feed portion 14 is arranged under the image forming portion 13, and is comprised of a manual feed tray 50, a duplex unit 55 and a sheet tray 51 in the main body and paper feed trays 52 and 53 provided in a multiple paper feed unit. There is a conveying means (sheet feed path) 57 for conveying the paper fed from these trays 51, 52 and 53 to the transfer station where the transfer device is arranged in image forming portion 13.

Arranged in front of duplex unit 55 is a switchback path 56 for inverting the recording paper. This path is used when images are formed on both sides of the recording paper. Here, duplex unit 55 is constructed so as to be interchangeable with a normal paper cassette. That is, duplex unit 55 may be replaced by a normal paper cassette.

Next, the configuration of toner supply device 100 according to the present embodiment will be described with reference to the drawings.

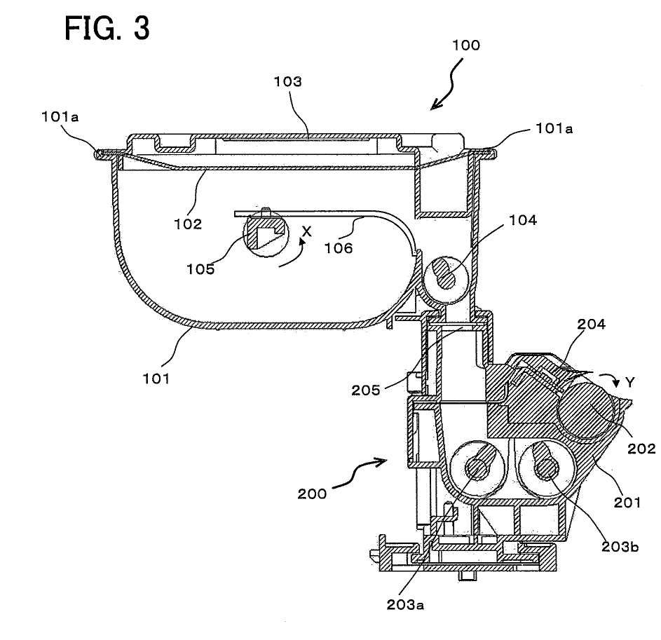

FIG. 3 is a sectional view showing the positional relationship between toner supply device 100 and developing unit 200 in the present embodiment.

Toner supply device 100 is filled with toner, and is generally called a toner container or toner cartridge.

The toner supply device 100 herein is composed of a toner storage tank 101, a sealing element 102, a covering member 103 for lidding from above the seal, a toner supply roller 104 for supplying toner to developing unit 200 arranged below and a toner conveying member 106 provided for a toner agitation shaft base 105 for supplying toner uniformly to the toner supply roller 104. This toner supply device is constructed to supply toner from a top opening 205 of developing unit 200 by rotating toner supply roller 104 in accordance with a toner supply request signal from developing unit 200 or the image forming apparatus body. Here, toner conveying member 106 rotates in the X-direction.

Developing unit 200 is constructed of a developer storage hopper 201, a developing roller 202 rotating in the Y-direction, toner conveying rollers 203a and 203b and a doctor blade 204 for adjusting the height of the developer spike.

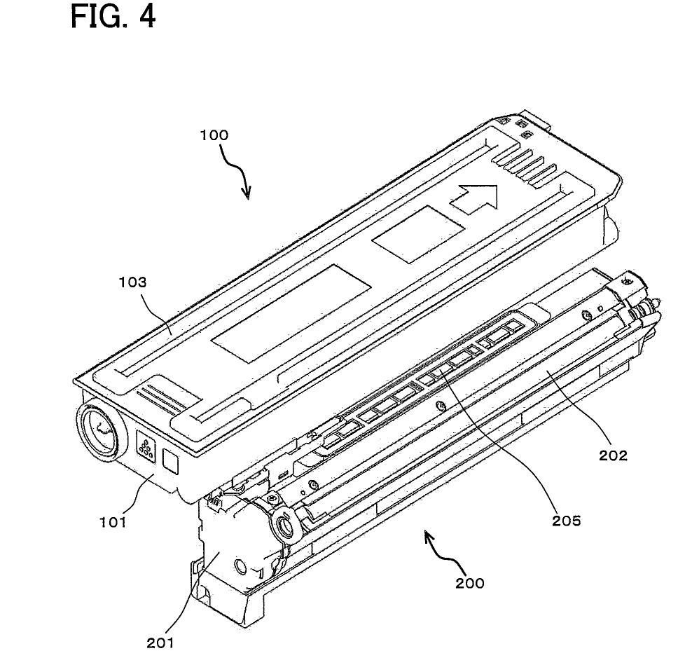

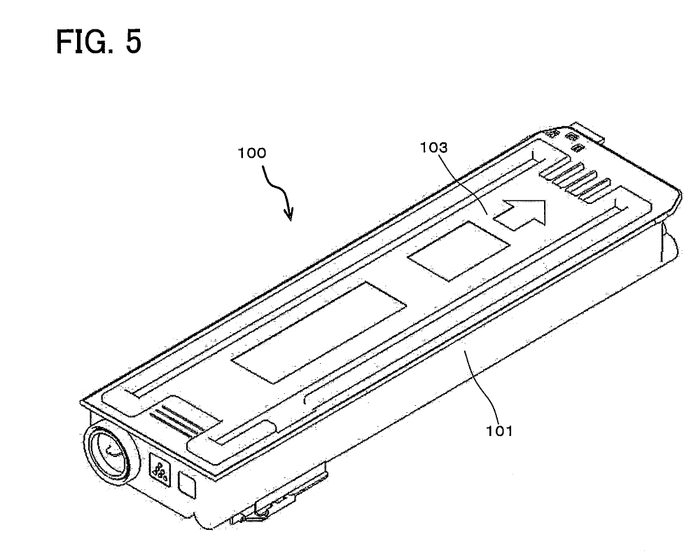

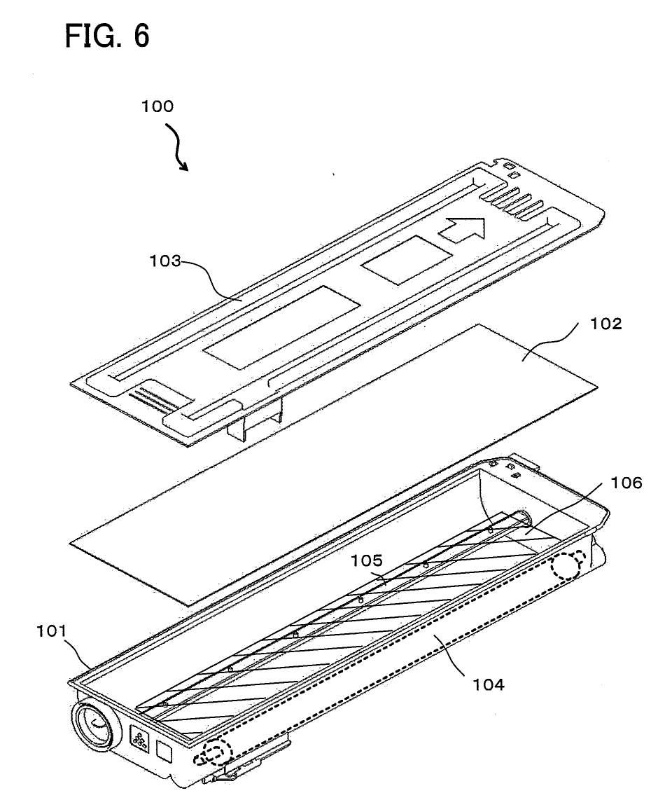

FIG. 4 is a perspective view showing the overall configuration of toner supply device 100 and developing unit 200. FIG. 5 is a perspective view showing toner supply device 100 alone.

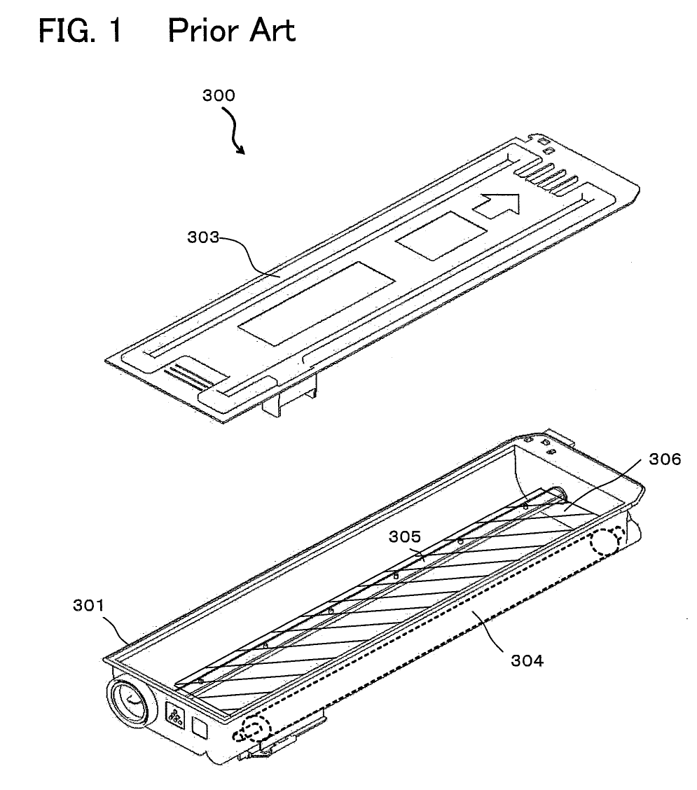

Toner supply device 100 shown in FIGS. 4 and 5 looks externally similarly to the conventional toner supply device 300 shown in FIG. 1 because only toner storage tank 101 and covering member 103 can be seen.

Next, the interior of toner supply device 100 will be described using FIG. 6. When toner supply device 100 is decomposed, sealing element 102, toner agitation shaft base 105, toner conveying member 106 and toner, though not shown, are contained therein.

Sealing element 102 may use any material as long as it bonds to the top wall surface, designated at 101a of toner storage tank 101. However, from a workability viewpoint, heat sealing materials are preferably used. As specific examples, CMPS (the trade name of a polyethylene polymer manufactured by DU PONT-MITSUI POLYCHEMICALS CO., LTD.), TORAYFAN (the trade name of a polypropylene film manufactured by TORAY INDUSTRIES, INC.) may be used and applied by fusing with heat at a temperature of one hundred some tens deg. C. Here, as to application of the heat sealing material, spilling of the toner occurring when a sudden reduction in air pressure takes place during air transportation etc., can be more properly prevented when the sealing element is applied with slack than when it is applied tightly by sizing it exactly to the top dimensions of toner storage tank 101.

As the resin used for toner agitation shaft base 105 for supporting toner conveying member 106, PS resin or ABS resin is preferably used. The reason is that these materials are inexpensive and have mechanical strength, and can be simply shaped with precision.

Though the necessary performance of sealing toner can be obtained by use of the heat sealing material alone, covering member 103 is arranged over it since the sealing element is poor in mechanical strength. Since this covering member 103 itself is not thermally welded to toner storage tank 101, it can be reused many times. This cover may be fixed by use of some claws (not shown) on toner storage tank 101 side.

Next, the reusing method of the toner supply device 100 will be described.

When the toner in toner supply device 100 runs out, it is dismounted and collected from the image forming apparatus. From the collected toner supply device 100, covering member 103 is removed and sealing element 102 is pulled off. Thereafter, a small quantity of toner residing at corners and edges is cleaned by air or other means. In this cleaning, toner supply roller 104 and the like are also cleaned up. Subsequently, a predetermined amount of toner is loaded into toner storage tank 101. Then, anew sealing element is applied and attached by thermal welding. Finally, covering member 103 is attached over it to complete the remanufacturing process of toner supply device 100. In this process, though the sealing element alone cannot be recycled, the other parts can be reused. Accordingly, this method can promote reduction of the total cost and reduce the processing time in remanufacturing.

Having described the preferred embodiment of the present invention with reference to the attached drawings, it goes without saying that the present invention should not be limited to the above-described examples. It is obvious that various changes and modifications will occur to those skilled in the art within the scope of the appended claims. Such variations are therefore understood to be within the technical scope of the present invention.

What is claimed is:

1. A toner supply device comprising:
a toner storage tank for storing toner;
a toner supply roller for discharging toner; and
a covering member for covering the top surface of the toner storage tank filled with toner,
characterized in that a sealing element is provided between the toner storage tank and the covering member.

2. The toner supply device according to claim 1, wherein the sealing element is formed of a heat sealing material.

3. The toner supply device according to claim 1, further comprising:
a toner conveying member for conveying toner; and
a toner agitation shaft base for supporting the toner conveying member.

4. The toner supply device according to claim 3, wherein the toner agitation shaft base is formed of PS resin or ABS resin.

5. A developing unit using a toner supply device according to claim 1.

6. A remanufacturing method of a toner supply device comprising: a toner storage tank for storing toner; a toner supply roller for discharging toner; a covering member for covering the top surface of the toner storage tank filled with toner; and a sealing element provided between the toner storage tank and the covering member, comprising the steps of:
cleaning a used toner storage tank;
loading the cleaned tank with the toner;
hermetically closing the toner storage tank filled with the toner with a new sealing element; and,
covering with the covering member the toner storage tank closed with the new sealing element.

7. The remanufacturing method of a toner supply device according to claim 6, wherein the replaced new toner sealing element is applied with slack so as to hermetically close the toner storage tank.
